(19) United States
(12) Patent Application Publication
(10) Pub. No.: US 2004/0065514 A1
(43) Pub. Date: Apr. 8, 2004

(54) Dual-brake system of a bicycle front hub

(76) Inventor: Ching-Shu Chen, Chang Hua City (TW)

Correspondence Address: John S. Egbert, Harrison & Egbert, 7th Floor, 412 Main Street, Houston, TX, 77002, US

(21) Appl. No.: 10/464,899

(22) Filed: Jun. 20, 2003

(30) Foreign Application Priority Data
Oct. 7, 2002 (TW) 91216027

(51) Int. Cl. B62L 1/00; B62L 3/00

(52) U.S. Cl. 188/24.11; 188/24.22

(57) ABSTRACT

A bicycle dual-brake system is mounted on a front fork and a front wheel hub of a bicycle. The system comprises two units, with one unit being fastened with one front-fork tube and one end of the front wheel hub, with other unit being fastened with other front-fork tube and other end of the front wheel hub. Both units are connected to the same brake lever mounted on a handlebar of the bicycle. Both units are formed of a disc fastened with the front wheel hub, a brake device fastened with the front fork, and a brake cable connecting the brake device to the brake lever.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a bicycle brake system, and more particularly to a bicycle dual-brake system.

### BACKGROUND OF THE INVENTION

As shown in FIGS. 3 and 4, a bicycle single-brake system of the prior art comprises a disc 61 and a brake device 62. The disc 61 is fastened with one end of a front hub 60. The brake device 62 is fastened with a front-fork tube 63 and is used to actuate the disc 61 to slow or stop the motion of a bicycle front wheel.

Such prior art single-brake system is sufficient in terms of function for a bicycle which is designed for use on an ordinary road or bicycle path. However, the prior art system is grossly insufficient for a bicycle which is used for performance, bicycle-racing, or riding on a rugged road. When the prior art single-brake system is at work, the two front-fork tubes are not uniformly exerted on by a stress that is resulted from the action of the single-brake system. In another words, the stress is concentrated on the front-fork tube 63 which is therefore particularly vulnerable to crack, as illustrated in FIG. 4. In addition, the braking action of the prior art single-brake system is out of balance, thereby causing the front wheel to skid. The skidding of the front wheel is particularly acute on a wet road.

### BRIEF SUMMARY OF THE INVENTION

The primary objective of the present invention is to provide a dual-brake system which is mounted on a bicycle front hub and is formed of a first disc, a first brake device, a second disk, and a second brake device. The first disc is fastened with one end of the bicycle front hub, while the first brake device is fastened with one front-fork tube. The second disc is fastened with other end of the bicycle front hub, while the second brake device is fastened with other front-fork tube. The first brake device and the second brake device are commonly connected to a brake lever mounted on a handlebar. As the brake lever is triggered, both brake devices are activated at the same time to bring about the braking action in conjunction with the first disc and the second disc.

The features and the advantages of the present invention will be more readily understood upon a thoughtful deliberation of the following detailed description of a preferred embodiment of the present invention with reference to the accompanying drawings.

### BRIEF DESCRIPTION OF THE SEVERAL VIEWS OF THE DRAWINGS

FIG. 1 shows a perspective view of the preferred embodiment of the present invention.

FIG. 2 shows a front view of the preferred embodiment of the present invention.

FIG. 3 shows a perspective view of a bicycle front hub brake system of the prior art.

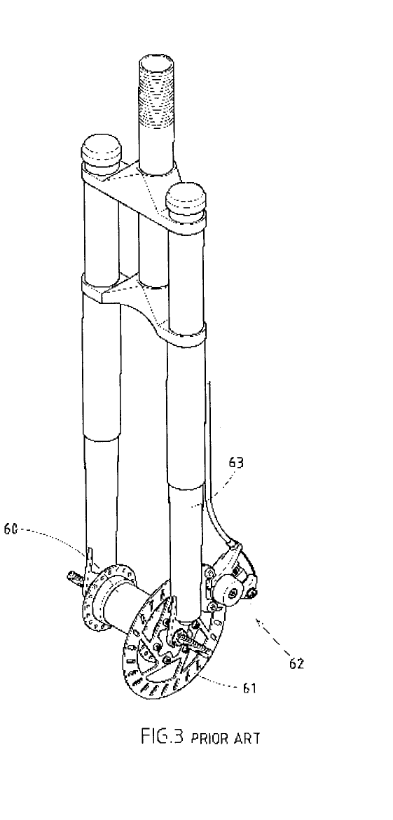

FIG. 4 shows a front view of the bicycle front hub brake system of the prior art.

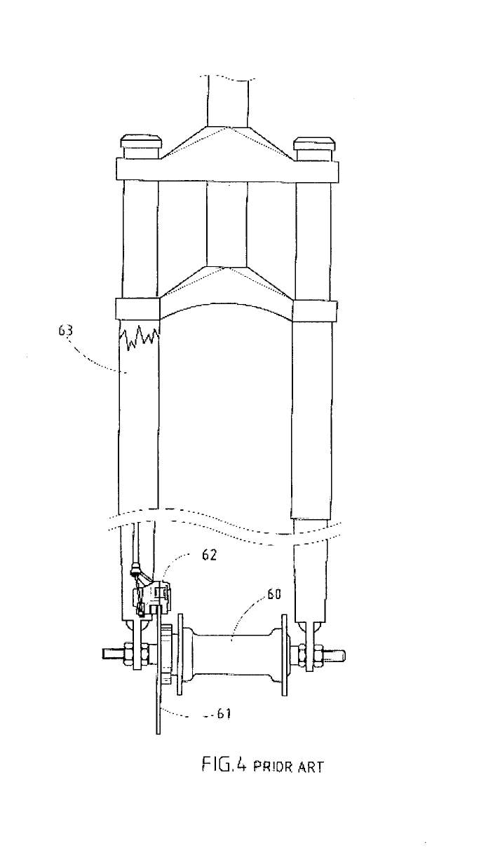

### DETAILED DESCRIPTION OF THE INVENTION

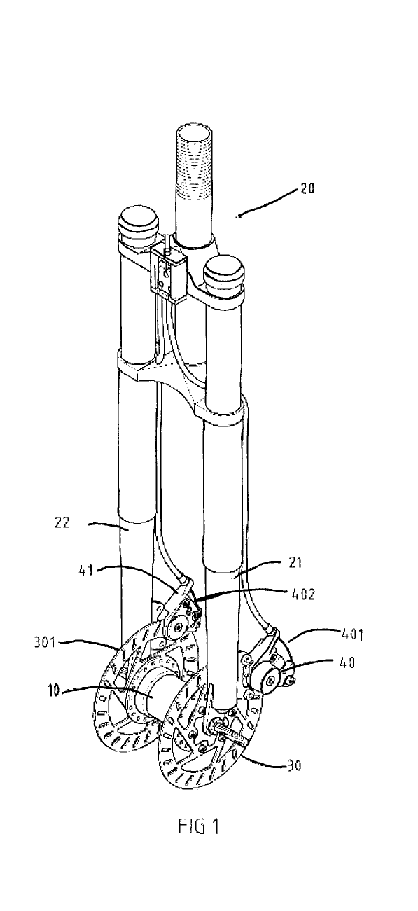

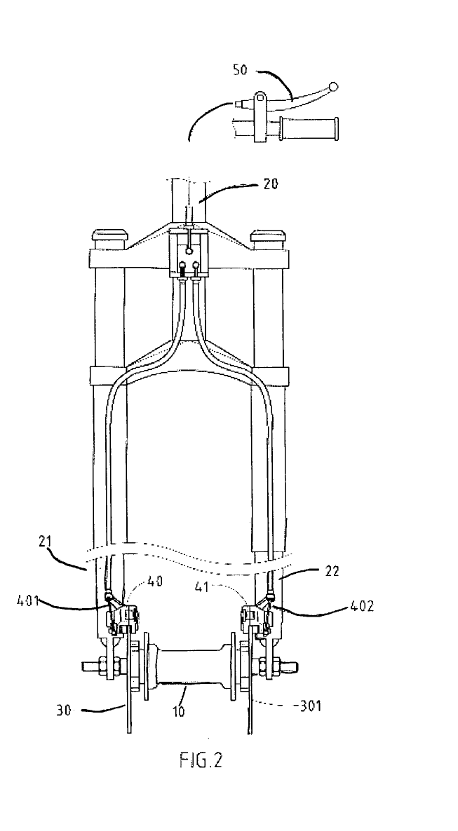

As shown in FIGS. 1 and 2, a dual-brake system embodied in the present invention is mounted on a bicycle front hub 10 and is formed of a first disc 30, a first brake device 40, a second disc 301, and a second brake device 41. The first disc 30 and the first brake device 40 work together as a first unit, while the second disc 301 and the second brake device 41 work together as a second unit. The first unit is associated with one end of the bicycle front hub 10 as well as one front-fork tube 21. The second unit is associated with the other end of the bicycle front hub 10 and the other front-fork tube 22. The first brake device 40 comprises a first brake cable 401 which is connected to a brake lever 50 mounted on the handlebar via a head tube 20. The second brake device 41 comprises a second brake cable 402 which is connected to the brake lever 50. As a result, when the brake lever 50 is triggered, both the first unit and the second unit are activated at the same time to bring about a braking effect. The braking effect of the dual-brake system of the present invention is well balanced to avert the skidding of the bicycle front wheel, and to prolong the service life span of the front-fork tubes 21 and 22.

I claim:

1. A bicycle dual-brake system comprising:
a first unit associated with a first end of a bicycle front wheel hub and a first front-fork tube of the bicycle, said first unit comprising a first disc fastened with the first end of the bicycle front wheel hub, a first brake device fastened with the first front-fork tube of the bicycle to effect said first disc, and a first brake cable connecting said first brake device with a brake lever mounted on a handlebar of the bicycle; and
a second unit associated with a second end of the bicycle front wheel hub and a second front-fork tube of the bicycle, said second unit comprising a second disc fastened with the second end of the bicycle front wheel hub, a second brake device fastened with the second front-fork tube of the bicycle to effect said second disc, and a second brake cable connecting said second brake device with the brake lever mounted on the handlebar of the bicycle.
